(19) United States
(12) Patent Application Publication
(10) Pub. No.: US 2015/0033190 A1
(43) Pub. Date: Jan. 29, 2015

(54) IMAGE SWITCHING APPARATUS, IMAGE SWITCHING SYSTEM, AND IMAGE SWITCHING METHOD

(71) Applicant: Sharp Kabushiki Kaisha, Osaka (JP)

(72) Inventor: Tatsuaki Amemura, Osaka (JP)

(21) Appl. No.: 14/337,428

(22) Filed: Jul. 22, 2014

(30) Foreign Application Priority Data
Jul. 24, 2013 (JP) 2013-153403

(51) Int. Cl. G06F 3/0481; G06F 3/0484

(52) U.S. Cl. CPC G06F 3/04817; G06F 3/04842
USPC 715/835

(57) ABSTRACT

A display controller which is carried out as an image switching apparatus switches images output from a multifunction peripheral and an expansion apparatus which are a plurality of electronic devices having different OSes to display on a display portion. A display control portion controls the display portion to display a home screen showing at once icons for running an application which operates in the multifunction peripheral or the expansion apparatus. A judging portion inputs operation information showing the fact that a specific icon is selected from the home screen displayed on the display portion and judges the selected icon. The display control portion controls the display portion to display an image from an electronic device in which an application corresponding to the selected icon operates according to judgment result by the judging portion.

### CROSS-NOTING PARAGRAPH

This non-provisional application claims priority under 35 U.S.C. §119(a) on Patent Application No. 2013-153403 filed in JAPAN on Jul. 24, 2013, the entire contents of which are hereby incorporated herein by reference.

### FIELD OF THE INVENTION

The present invention relates to an image switching apparatus for enabling applications which operate on different OSes (Operating Systems) to be used in one system, an image switching system, and an image switching method.

### BACKGROUND OF THE INVENTION

There is a system in which a plurality of electronic devices where an application operates are used, the application of these electronic devices is executed as appropriate, and a resulting image is displayed on a screen. In this case, in order to enable displaying an image from an electronic device in which an application desired by a user operates, desired execution result by the application of the electronic device of a switching destination is able to be obtained normally by switching input of the image by user operation.

Moreover, various different OSes are used these days, and also, depending on electronic devices, some OSes which operate are different. In this case, when an image output from an electronic device is switched according to an application to be used, it is necessary that an OS operating in an electronic device in which an image is being displayed is switched to an OS of an electronic device which generates an image after switching to display the image by an application which operates on the OS after switching.

As for a technology whereby display of applications which operate on different OSes are switched, in Japanese Laid-Open Patent Publication No. 2011-197853, for example, a function providing apparatus to enable switching a virtual environment without making a user aware even if the virtual environment needs to be switched in order to execute a selected function and a program are disclosed.

In this function providing apparatus, a hypervisor for operating a plurality of OSes as a virtual environment respectively is provided. Further, in the hypervisor, a control processing portion for performing processing regarding control of a provided function and a UI processing portion for performing processing regarding a user interface related to the corresponding function are set. These processing portions are provided in set units to each of the OSes in a distributed manner, an OS of one side which is provided with a processing portion regarding a menu management function is set as a screen sharing server, a display request output from a UI processing portion of another OS side is provided to the OS of one side, and a screen in accordance with the display request is displayed.

As described above, in a system in which images from a plurality of electronic devices are switched to be displayed as appropriate, at a time of switching the electronic devices, operation that the user switches OSes intentionally is necessary.

On the other hand, if all of the intended applications are set together in one electronic device in which a specific OS operates, the user is able to omit the operation of switching OSes according to a desired application, thus resulting in high convenience.

In the case of setting applications integrally for one OS, however, when an application which the user possesses as an asset is not compatible with the intended OS, the application needs to be transplanted and optimized so as to be compatible with the intended OS.

Therefore, when one system is newly constructed, even in the case of possessing applications which operate on different OSes as assets, necessity of transplanting to an application which is suitable for an OS of the system occurs, so that a development time and a cost of the system become enormous.

In addition, the technology of Japanese Laid-Open Patent Publication No. 2011-197853 is a characterized in that, in order to operate the plurality of OSes in one system, the hypervisor for operating the plurality of OSes as virtual environments is provided. Categorizing hypervisors according to operation systems, there are a system in which a hypervisor directly operates on hardware first and all OSes (guest OSes) operate on the hypervisor and an operation system by a hypervisor which operates as an application on a host OS. Moreover, as the virtualization described above, there are two types of virtualization technologies of full virtualization and paravirtualization.

In the case of a configuration on the assumption of usage of a hypervisor like Japanese Laid-Open Patent Publication No. 2011-197853, however, only OSes capable of operating on an adopted hypervisor are able to be used. Accordingly, new OSes which are not able to operate on the hypervisor and OSes customized uniquely by a user are substantially unable to be used.

In addition, in the case of virtualization, performing full virtualization degrades performance significantly. Moreover, in this case, a load to a CPU increases inevitably. On the other hand, in the case of performing paravirtualization, modification on a guest OS for the adopted hypervisor becomes necessary. Further, since change of a source code of the OS is necessary for that purpose, it is impossible to use an OS for general use such as Windows (registered trademark), for example.

### SUMMARY OF THE INVENTION

The present invention aims to provide an image switching apparatus for, in a system in which applications operating on different OSes are used, enabling switching screen display of an arbitrary application without making a user aware of switching OSes nor without degrading performance of operation, an image switching system, and an image switching method.

An object of the present invention is to provide an image switching apparatus which switches images output from a plurality of electronic devices having different Operating Systems to display on a predetermined display portion, comprising: a display control portion for controlling the display portion to display a home screen showing at once all of icons for running an application which operates in any one of the plurality of electronic devices; and a judging portion for inputting operation information showing the fact that a specific icon is selected from the home screen displayed on the display portion, and for judging the selected icon based on the input operation information; wherein the display control portion controls the display portion to display an image output from an electronic device in which an application corresponding to the selected icon operates according to a judgment result by the judging portion.

Another object of the present invention is to provide the image switching apparatus, wherein the home screen is obtained from the electronic device which outputs the image being displayed on the display portion.

Another object of the present invention is to provide the image switching apparatus, wherein a storage portion for storing the home screen in advance is included, and the display control portion displays the home screen read from the storage portion on the display portion.

Another object of the present invention is to provide an image switching system which includes a plurality of electronic devices having different Operating Systems, a display portion for displaying an image, an operation portion for receiving operation input with respect to the image displayed on the display portion, and an image switching apparatus which switches images output from the plurality of electronic devices for displaying on the display portion; wherein the image switching apparatus includes a display control portion for controlling the display portion to display a home screen showing at once all of icons for running an application which operates in anyone of the plurality of electronic devices, and a judging portion for, in a case where operation that a specific icon is selected from the home screen displayed on the display portion is performed with respect to the operation portion, inputting operation information output from the operation portion, and for judging the selected icon based on the input operation information, the operation information is input to the plurality of electronic devices, an electronic device which retains an application corresponding to the selected icon starts the selected application to output an image generated by the application to the display control portion, and the display control portion controls the display portion to display the image output from the electronic device in which the application corresponding to the selected icon operates according to a judgment result by the judging portion.

Another object of the present invention is to provide an image switching method executed by an image switching apparatus which switches images output from a plurality of electronic devices having different Operating Systems to display on a predetermined display portion, comprising: a step that the image switching apparatus causes the display portion to display a home screen showing at once all of icons for running an application which operates in any one of the plurality of electronic devices; a judging step that the image switching apparatus inputs operation information showing the fact that a specific icon is selected from the home screen displayed on the display portion, and for judging the selected icon based on the input operation information; and a step that the image switching apparatus controls the display portion to display an image output from an electronic device in which an application corresponding to the selected icon operates according to a judgment result by the judging step.

### BRIEF DESCRIPTION OF THE DRAWINGS

FIG. 1 is a view explaining a configuration example of an embodiment 1 of the present invention;

FIG. 2 is a view for explaining a function of an image switching apparatus applied to a system of FIG. 1;

FIG. 3 is a view showing a configuration example of a home screen; and

FIG. 4 is a view explaining a configuration example of an embodiment 3 of the present invention.

### PREFERRED EMBODIMENTS OF THE INVENTION

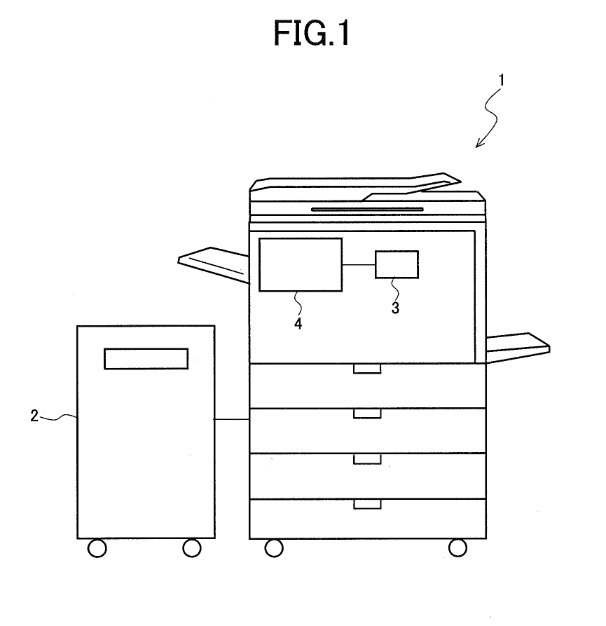

FIG. 1 is a view explaining a configuration example of an embodiment 1 of the present invention. In an image switching system, a plurality of electronic devices in which applications operate are provided. For these electronic devices, ones which operate on OSes different from each other are able to be used.

In this example, as one example of the plurality of electronic devices, a multifunction peripheral (MFP) 1 which is provided with a plurality of functions such as a copier function, a printer function, a facsimile function, and a data filing function and an expansion apparatus (also referred to as application box) 2 which has a expansion function of an application are to be used.

Further, in the image switching system of the present example, a shared display 4 for displaying a screen generated by the multifunction peripheral 1 and a screen generated by the expansion apparatus 2 and a display controller 3 for switching screens to be displayed on the shared display 4 are provided. The display controller 3 is shown in a manner of being attached to the multifunction peripheral 1, but is able to be configured integrally with the shared display, or to be embedded inside a main body of the multifunction peripheral 1. Moreover, the shared display 4 is integrally attached to the main body of the multifunction peripheral 1. In this case, as the shared display 4, a display which is originally provided in the multifunction peripheral 1 is able to be applied, but it may be one installed in addition to the display of the multifunction peripheral 1. The display controller 3 which appropriately switches screens, which are from these electronic devices, to display on the shared display 4 corresponds to the image switching apparatus of the present invention.

In the multifunction peripheral 1, an application for executing the plurality of functions as described above operates, and an image generated by the application is output to the display controller 3. In the same manner, also in the expansion apparatus 2, an image generated by an application which operates in the expansion apparatus 2 is output to the display controller 3. The OSes which operate in the multifunction peripheral 1 and the expansion apparatus 2 are different OSes, and the display controller 3 switches screens of the applications which operate on each OS to display.

At this time, the display controller 3 causes the shared display 4 to display a screen in which icons for selecting applications which operate on different OSes of the multifunction peripheral 1 and the expansion apparatus 2 for execution are displayed at once. In accordance with selection operation of the icon by a user, then control is performed so as to switch display of the shared display 4 to display of the multifunction peripheral 1 or the expansion apparatus 2 which is provided with an OS on which the selected application is capable of operating. This makes it possible to switch screen display of an arbitrary application without making a user aware of switching OSes nor applications, nor without degrading performance of executing applications.

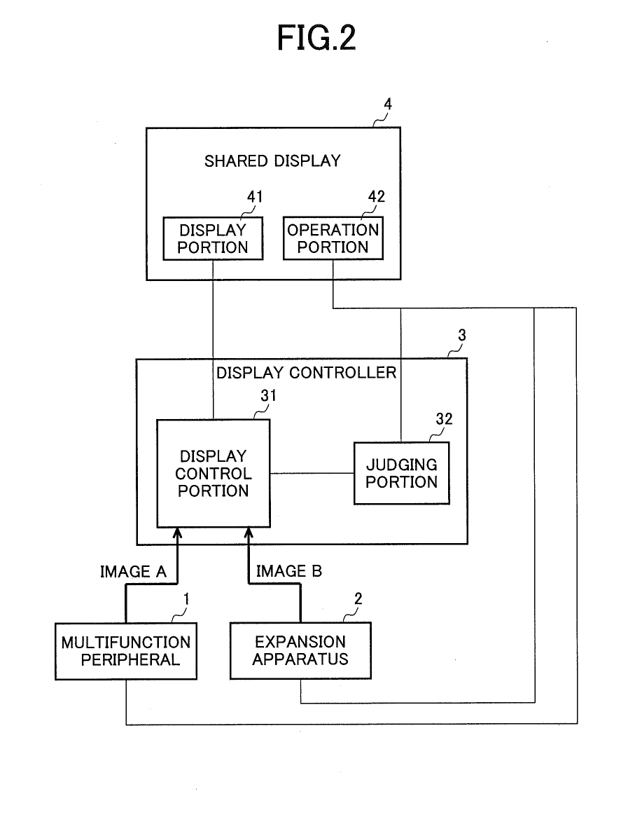

FIG. 2 is a view for explaining a function of the image switching apparatus applied to the system of FIG. 1. In the display controller 3, a display control portion 31 to which an image generated by an application which operates on an OS of the multifunction peripheral 1 (set as an image A) and an image generated by an application which operates on an OS of the expansion apparatus 2 (set as an image B) are input and which switches these images to display on a display portion 41 of the shared display 4 and a judging portion 32 for judging selection operation of an icon by the user are provided.

The shared display 4 is provided with the display portion 41 such as a liquid crystal panel and an operation portion 42 which receives operation input with respect to the display portion 41. A touch panel is able to be composed of the display portion 41 and the operation portion 42. When the user operates the operation portion 42, operation input for selecting an icon displayed on the display portion 41 to execute an application is able to be performed.

The display control portion 31 causes the shared display 4 to display a screen in which an icon enabling selection of the application which operates on the OS of the multifunction peripheral 1 and an icon enabling selection of the application which operates on the OS of the expansion apparatus 2 are assembled into one (set as a home screen). Using the touch panel, the user is able to perform operation input for selecting an arbitrary application from the home screen displayed on the shared display 4 for execution.

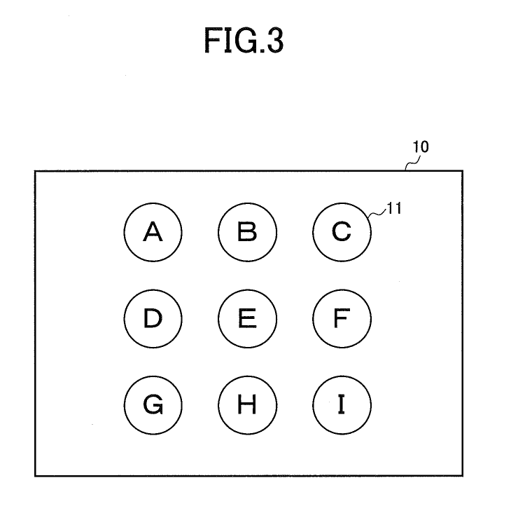

The home screen is configured as shown in FIG. 3, for example. In a home screen 10 displayed on the display portion 41, a plurality of icons 11 are displayed at once in a list. Here, the icons 11 may be displayed separately in a plurality of screens. The icons 11 of the home screen 10 shown in FIG. 3 are shown as A, B, C, . . . for explanation, but each of the icons 11 is designed, for example, for each application and used as an icon which shows the application.

In this home screen 10, an icon which operates on the OS of the multifunction peripheral 1 and an icon which operates on the OS of the expansion apparatus 2 are assembled to be displayed. These icons are not necessary to be distinguished for each OS, and may be mixed suitably. This makes it possible for the user to perform operation for selecting an arbitrary application without particularly being aware which OS the application operates on.

The description will be given, returning to FIG. 2. In the embodiment 1, the home screen as described above is able to be retained in advance in both or either of the expansion apparatus 2 and the multifunction peripheral 1, for example. When an image from the expansion apparatus 2 is displayed in a predetermined default state such as in a case where a system starts or when the home screen is displayed according to predetermined user operation while the image from the expansion apparatus 2 is being displayed, the display control portion 31 of the display controller 3 controls the display portion 41 of the shared display 4 to display an image of the home screen output from the expansion apparatus 2.

Moreover, when screen display of the multifunction peripheral 1 is performed in the predetermined default state or when the home screen is displayed according to the predetermined user operation while an image from the multifunction peripheral 1 is being displayed, the display controller 3 controls the display portion 41 to display the home screen output from the multifunction peripheral 1.

By keeping the multifunction peripheral 1 and the expansion apparatus 2 to retain the home screen, the home screen is able to be output and displayed as it is from an electronic device which is targeted for image display.

In addition, as an embodiment 2 of the present invention, the display controller 3 may retain the above-described home screen. In this case, the display controller 3 is provided with a memory (storage portion) for retaining the home screen, and the display control portion 31 reads the home screen from the memory to perform control for displaying on the display portion 41 in the case of the predetermined default state or in the case of displaying the home screen according to the user operation.

With a configuration in which the home screen is retained by the display controller 3, it is possible to move both of the multifunction peripheral 1 and the expansion apparatus 2 to an energy saving mode or a sleep mode in a state where the home screen is displayed, resulting in that an effect of reducing power consumption is able to be obtained.

In both cases of the embodiments 1 and 2, in the shared display 4, when operation for selecting a specific icon is input by the operation portion 42 while the home screen is displayed on the display portion 41, the operation information is input into the judging portion 32 of the display controller 3.

Based on the operation information of the input icon, the judging portion 32 judges a device in which the selected icon operates, that is, the multifunction peripheral 1 or the expansion apparatus 2, and instructs the display control portion 31 to cause the display portion 41 to display an image output from the device.

Further, the operation information of selecting an icon from the operation portion 42 is also output to the multifunction peripheral 1 and the expansion apparatus 2. Then, the multifunction peripheral 1 and the expansion apparatus 2, in the case of retaining an application corresponding to the selected icon by themselves, start the application, perform processing by the application, and output a generated image to the display control portion 31. In the display control portion 31, according to judgment result by the judging portion 32, control is performed so as to display the image from the device, in which the application has been started, on the display portion 41. The image output from the device in which the application has been started is thereby displayed on the display portion 41 of the shared display 4.

With the above-described configuration, it is possible to start the application in the corresponding electronic device according to selection operation of the icon from the home screen using the home screen displaying the icons at once, and to cause the output image to be displayed. This makes it possible to perform switching to an image of an arbitrary application without making the user aware of switching OSes. In addition, since each application operates on hardware of each electronic device (in the above-described example, the multifunction peripheral 1 and the expansion apparatus 2), degrading of performance does not occur in operation of the applications. Moreover, for each application, one that originally operates on the OS in each of the electronic devices is used, so that it is not necessary to perform transplantation nor optimization of the application for integration of the OSes.

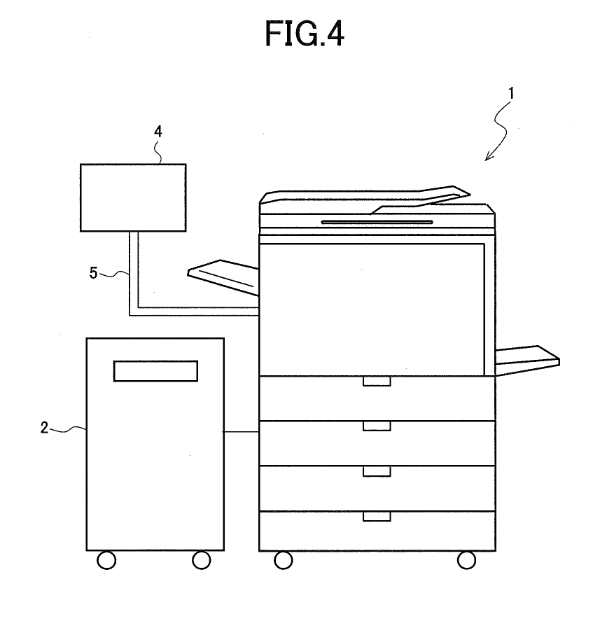

FIG. 4 is a view explaining a configuration example of an embodiment 3 of the present invention. This embodiment is configured by providing the shared display 4, which is integrally attached to the main body of the multifunction peripheral 1 in the embodiment 1, so as to be independently separated from the main body of the multifunction peripheral 1, and other configurations and operation are the same as those of the embodiment 1.

In this example, the shared display 4 is hold to the main body of the multifunction peripheral 1 by a retaining member 5, but there is no limitation to such a configuration as long as the shared display 4 is provided separately from the main body of the multifunction peripheral 1.

In this case, the display controller 3 for switching screens to be displayed on the shared display 4 is able to be incorporated in the shared display 4. Alternatively, the display controller 3 may be incorporated inside the main body of the multifunction peripheral 1.

Moreover, as shown in FIG. 2, in the shared display 4, the display portion 41 and the operation portion 42 are provided and a touch panel capable of user operation is configured. In this case, an operation panel provided in the main body of the multifunction peripheral 1 may be omitted, so that all of the user operation is received in the shared display 4.

Since other configurations and operation are the same as those of the embodiment 1, the repeating explanation thereof will be omitted.

In addition, in the configuration of the embodiment 3, the home screen may be retained by the display controller 3 in the same manner as that of the embodiment 2.

As explained above, the image switching apparatus of the present invention is an image switching apparatus which switches images output from a plurality of electronic devices having different OSes to display on a predetermined display portion, which includes a display control portion for controlling the display portion to display a home screen showing at once all of icons for running an application which operates in any one of the plurality of electronic devices and a judging portion for inputting operation information showing the fact that a specific icon is selected from the home screen displayed on the display portion in order to judge the selected icon based on the input operation information, and which is characterized in that the display control portion controls the display portion to display an image output from an electronic device in which an application corresponding to the selected icon operates according to judgment result by the judging portion. This then makes it possible to, in a system in which applications operating on different OSes are used, switch screen display of an arbitrary application without making a user aware of switching OSes nor without degrading performance of operation.

Moreover, the image switching apparatus of the present invention is characterized in that the home screen is obtained from the electronic device outputting the image being displayed on the display portion. This then makes it possible to cause the home screen to be output and displayed as it is from the electronic device which is targeted for image display.

Moreover, the image switching apparatus of the present invention is characterized in that a storage portion for storing the home screen in advance is included, and the display control portion displays the home screen read from the storage portion on the display portion. This makes it possible to move the plurality of electronic devices to an energy saving mode or a sleep mode, resulting in that an effect of reducing power consumption is able to be obtained.

Moreover, an image switching system of the present invention is an image switching system which includes a plurality of electronic devices having different OSes, a display portion for displaying an image, an operation portion for receiving operation input with respect to the image displayed on the display portion, and an image switching apparatus which switches images output from the plurality of electronic devices for displaying on the display portion, which is characterized in that the image switching apparatus includes a display control portion for controlling the display portion to display a home screen showing at once all of icons for running an application which operates in any one of the plurality of electronic devices, and a judging portion for, in a case where operation that a specific icon is selected from the home screen displayed on the display portion is performed with respect to the operation portion, inputting operation information output from the operation portion to judge the selected icon based on the input operation information, the operation information is input to the plurality of electronic devices, an electronic device which retains an application corresponding to the selected icon starts the selected application to output an image generated by the application to the display control portion, and the display control portion controls the display portion to display the image output from the electronic device in which the application corresponding to the selected icon operates according to judgment result by the judging portion. This makes it possible to, in a system in which applications operating on different OSes are used, switch screen display of an arbitrary application without making a user aware of switching OSes nor without degrading performance of operation.

Moreover, an image switching method of the present invention is an image switching method executed by an image switching apparatus which switches images output from a plurality of electronic devices having different OSes to display on a predetermined display portion, which is characterized in that a step that the image switching apparatus causes the display portion to display a home screen showing at once all of icons for running an application which operates in any one of the plurality of electronic devices, a judging step that the image switching apparatus inputs operation information showing the fact that a specific icon is selected from the home screen displayed on the display portion in order to judge the selected icon based on the input operation information, and a step that the image switching apparatus controls the display portion to display an image output from an electronic device in which an application corresponding to the selected icon operates according to judgment result by the judging step are included. This then makes it possible to, in a system in which applications operating on different OSes are used, switch screen display of an arbitrary application without making a user aware of switching OSes nor without degrading performance of operation.

Hereinabove, according to the present invention, it is possible to provide an image switching apparatus for, in a system in which applications operating on different OSes are used, enabling switching screen display of an arbitrary application without making a user aware of switching OSes nor without degrading performance of operation, an image switching system, and an image switching method.

1. An image switching apparatus which switches images output from a plurality of electronic devices having different Operating Systems to display on a predetermined display portion, comprising:
a display control portion for controlling the display portion to display a home screen showing at once all of icons for running an application which operates in any one of the plurality of electronic devices; and
a judging portion for inputting operation information showing the fact that a specific icon is selected from the home screen displayed on the display portion, and for judging the selected icon based on the input operation information; wherein
the display control portion controls the display portion to display an image output from an electronic device in which an application corresponding to the selected icon operates according to a judgment result by the judging portion.

2. The image switching apparatus as defined in claim 1, wherein the home screen is obtained from the electronic device which outputs the image being displayed on the display portion.

3. The image switching apparatus as defined in claim 1, wherein
a storage portion for storing the home screen in advance is included, and
the display control portion displays the home screen read from the storage portion on the display portion.

4. An image switching system which includes a plurality of electronic devices having different Operating Systems, a display portion for displaying an image, an operation portion for receiving operation input with respect to the image displayed on the display portion, and an image switching apparatus which switches images output from the plurality of electronic devices for displaying on the display portion; wherein
the image switching apparatus includes
a display control portion for controlling the display portion to display a home screen showing at once all of icons for running an application which operates in any one of the plurality of electronic devices, and
a judging portion for, in a case where operation that a specific icon is selected from the home screen displayed on the display portion is performed with respect to the operation portion, inputting operation information output from the operation portion, and for judging the selected icon based on the input operation information,
the operation information is input to the plurality of electronic devices, an electronic device which retains an application corresponding to the selected icon starts the selected application to output an image generated by the application to the display control portion, and
the display control portion controls the display portion to display the image output from the electronic device in which the application corresponding to the selected icon operates according to a judgment result by the judging portion.

5. An image switching method executed by an image switching apparatus which switches images output from a plurality of electronic devices having different Operating Systems to display on a predetermined display portion, comprising:
a step that the image switching apparatus causes the display portion to display a home screen showing at once all of icons for running an application which operates in any one of the plurality of electronic devices;
a judging step that the image switching apparatus inputs operation information showing the fact that a specific icon is selected from the home screen displayed on the display portion, and for judging the selected icon based on the input operation information; and
a step that the image switching apparatus controls the display portion to display an image output from an electronic device in which an application corresponding to the selected icon operates according to a judgment result by the judging step.
